(19) United States
(12) Patent Application Publication
(10) Pub. No.: US 2008/0060995 A1
(43) Pub. Date: Mar. 13, 2008

(54) Semi-Permeable Membrane

(76) Inventors: Sean Zhang, Palo Alto, CA (US); Janice H. Nickel, Palo Alto, CA (US); Patricia A. Beck, Palo Alto, CA (US); Lung Tran, Palo Alto, CA (US); Shuhuai Yao, Pleasanton, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/531,181

(22) Filed: Sep. 12, 2006

(51) Int. Cl. B01D 71/06

(52) U.S. Cl. 210/490; 210/500.27; 264/41; 210/500.35

(57) ABSTRACT

A composition of matter and methods to produce the same. The composition of matter includes a thin film and a plurality of smooth-surfaced through-holes extending through the thin film. The thin film may have a thickness of between 200 nm and 150 μm. The through-holes may have a diameter of between 20 nm and 2500 nm.

### BACKGROUND

Mechanisms for the containment and directed movement of fluids are vital to any fluidics system. With the introduction of micro-electrical, mechanical systems (MEMS), microinjection systems, and other micro- (or even nano-) scale technologies, traditional mechanical solutions (such as micro-valves) are becoming increasingly expensive and ineffective.

For example, current MEMS valves are typically made of multiple layers of lithographically defined materials, which can be costly to produce, and defect-prone resulting in limited yield and increased development and production costs. In addition, micro-valves are likely to be subjected to film stress and may contain moving parts which can break and/or get “stuck.” Moreover, the moving parts in the valves tend to require a significant amount of power, placing limitations on the type of power source that can be used, decreasing portability and increasing the size of the device. Furthermore, it may not be possible to produce reliable mechanical valves on an extremely small scale (i.e. nanometer-sized scale), forcing manufacturers to produce chambers (and devices) that are larger than desired, and thereby placing unnecessary demands on sample volumes, reagents, and materials.

Fluid transportation may also be accomplished by electrowetting and electrophoresis. Electrowetting requires deposition of electrodes along the pathway of the fluid. Moreover, the volume of fluid that can be moved using this technique is constrained. Electrophoresis requires the formation of electrodes at either end of the fluid pathway and requires that the fluid to be moved have an electrical charge. Accordingly, both techniques impose requirements that may be undesirable, impractical, or even impossible for some applications.

Of course, the interest in fluid containment and transportation is not limited to micro devices, or even fluidics systems. For example, substances that prevent or reduce fluid penetration can be coated on fabrics to act as a water or soil barrier.

Accordingly, improved systems for directed movement and containment of fluids are desirable.

### BRIEF DESCRIPTION OF THE DRAWINGS

FIG. 1 provides a flow chart of a method for producing a semi-permeable membrane according to one embodiment of the present invention.

FIG. 2 depicts one embodiment of the present invention wherein a substrate is coated using roll-to-roll processing.

FIG. 3 is an SEM image of a membrane formed using the methods described in the present disclosure.

FIG. 4 is another SEM image of a membrane formed using the methods described in the present disclosure.

FIG. 5 shows a membrane of the present invention used as a fluid barrier over the opening of an empty fluidic chamber.

FIG. 6 shows the fluidic chamber of FIG. 4 after it has been filled with a fluid.

FIG. 7 shows the fluidic chamber of FIG. 5 after the membrane has burst and the fluid has been ejected from the chamber.

FIG. 8 shows the fluidic chamber of FIG. 5 after the fluid has been released from the chamber and the membrane kept intact.

### DETAILED DESCRIPTION

The present disclosure provides a semi-permeable membrane and methods for producing the same.

According to one embodiment, the present invention provides a semi-permeable film or membrane formed from a polymer. The polymer may be hydrophobic or hydrophilic, as desired, in order to impart such qualities to the membrane. According to some embodiments, the membrane may have a thickness of between 200 nm and 150 μm and include a plurality of smooth-surfaced through-holes extending through the membrane.

According to some embodiments, the through-holes may have a diameter of between 20 nm and 2500 nm. Moreover, the through-holes may have a substantially uniform density.

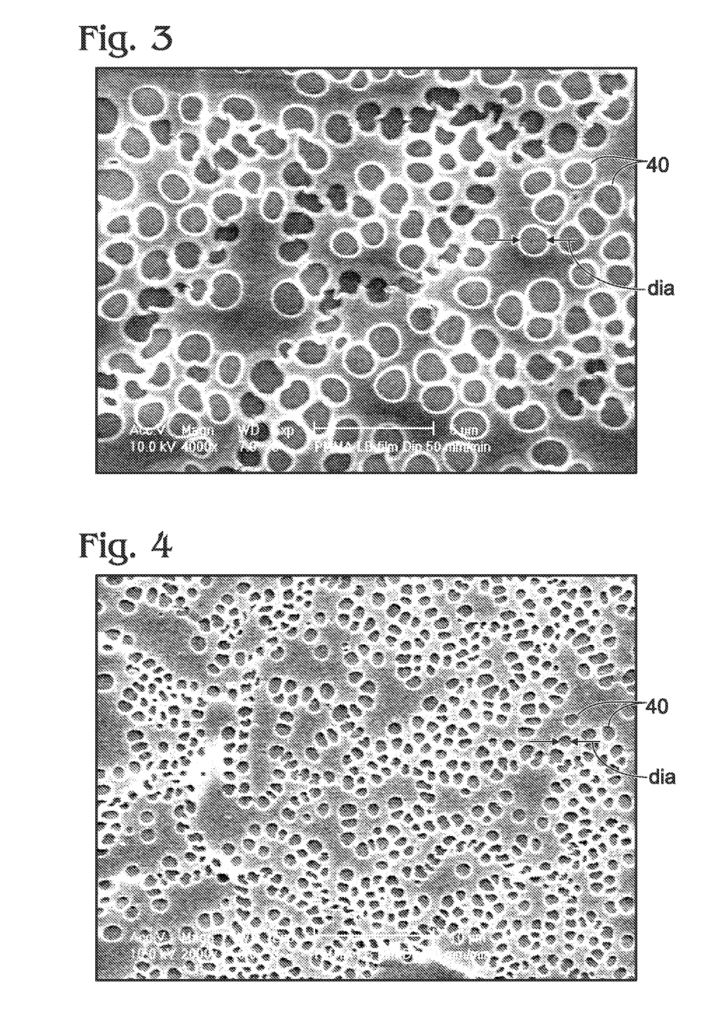

Scanning Electron Microscope (SEM) images of exemplary membranes according to this embodiment are shown in FIGS. 3 and 4.

According to one embodiment, and as described in greater detail below, the membrane may be adjacent to, formed on, attached to, or otherwise associated with a substrate. Accordingly, the membrane may be flexible, chemically dissolvable, or retain various other chemical and physical properties.

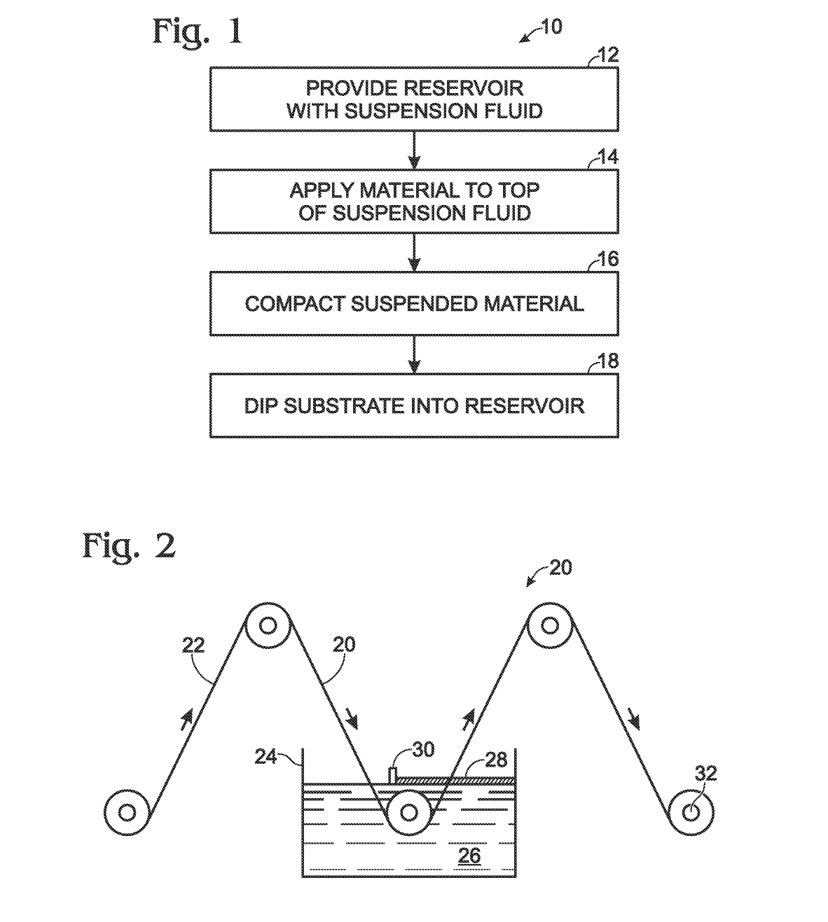

FIG. 1 is a flow chart depicting a method 10 for producing a semi-permeable membrane according to a first embodiment of the present invention.

At 12, a reservoir holding a suspension fluid is provided. According to one embodiment, the suspension fluid is water. However, other suspension fluids may be used including, for example, chloroform, dichloromethane and heavily halogenated solvents or polymers, water-salt systems such as brine or ammonium chloride, etc, simply ionic liquid such as [EtNH3] [NO3], etc. or binary ionic liquids from mixtures of aluminum (III) chloride and N-alkylpyridinium or 1,3-dialkylimidazolium chloride, etc. Of the above, water, or water-salt systems such as brine or ammonium chloride, etc, simply ionic liquid such as [EtNH3] [NO3], etc. or binary ionic liquids from mixtures of aluminum (III) chloride and N-alkylpyridinium or 1,3-dialkylimidazolium chloride, etc. would be suitable for the preparation of hydrophobic membranes while chloroform, methylene chloride, and other heavily halogenated solvents or polymers would be suitable for preparing hydrophilic membranes.

At 14, a liquid material or a solution of the material is applied to the top of the suspension fluid. According to one embodiment, the material may be applied to the surface of the suspension fluid, for example by pouring, spraying, jetting or other means. Regardless of the method used, the material is applied such that the material is able to spread out and form a thin film on top of the fluid.

Various types of materials may be used depending upon the desired properties of the semi-permeable membrane. According to one embodiment, the material is a hydrophobic polymer. Examples of suitable polymers include, but are not limited to, poly(methyl methacrylate) and its copolymer or block polymer, poly(alkyl acrylate) and its copolymer or block polymer, poly(alkyl methacrylate) and its copolymer or block polymer, poly(acrylamide) and its copolymer or block polymer, poly(N-alkyl acrylamide) and its copolymer or block polymer, poly(N-isopropyl acrylamide) and its copolymer or block polymer, poly(N,N-dialkyl acrylamide) and its copolymer or block polymer, poly(methacrylamide) and its copolymer or block polymer, poly(N-alkyl methacrylamide) and its copolymer or block polymer, poly(N-isopropyl methacrylamide) and its copolymer or block polymer, poly(N,N-dialkyl methacrylamide) and its copolymer or block polymer, poly(ethylene oxide) and its copolymer or block polymer, poly(vinyl chloride) and its copolymer or block polymer, poly(vinyl fluoride) and its copolymer or block polymer, poly(aryl ether) and its copolymer or block polymer, poly(vinyl ether) and its copolymer or block polymer, poly(vinyl acetate) and its copolymer or block polymer, poly(vinyl butyral) and its copolymer or block polymer, poly(vinyl formal) and its copolymer or block polymer, poly(acrylonitrile) and its copolymer or block polymer, poly(methacrylonitrile) and its copolymer or block polymer, poly(siloxane) and its copolymer or block polymer, and poly(styrene) and its copolymer or block polymer, poly(butylene) and its copolymer or block polymer, poly(isobutylene) and its copolymer or block polymer, poly(isoprene) and its copolymer or block polymer, poly(propylene) and its copolymer or block polymer, poly(methylpentene) and its copolymer or block polymer, poly(vinyl alcohol) and its copolymer or block polymer, poly(ethylene glycol) and its copolymer or block polymer. According to one embodiment, the polymer is dissolved in a suitable solvent before it is applied over the suspension fluid. Examples of suitable solvents include, but are not limited to, ethyl acetate, isopropyl alcohol, acetone, ethyl methyl ketone, acetophenone, N-methyl 2-pyrrolidinone, tetrahydrofuran, methylene chloride, anisole, xylene, toluene, chlorobenzene and chloroform, etc. It will be appreciated that the concentration of polymer in the solvent may be varied depending upon the particular materials used and the desired properties of the membrane. However, without wishing to be limited to only these concentrations, polymer concentrations of between about 0.1% and about 15% would be appropriate for certain applications.

At 16, the suspended material is compacted to form a membrane having a plurality of substantially uniformly sized through-holes (or pores). Examples of suitable compaction methods include, but are not limited to, Langmuir-Blodgett trough techniques, the use of pressure fields, contracting rings, and the like. The use of a Longmuir Blodgett technique is described below in the Examples section.

As stated, the membrane includes a plurality of substantially uniformly sized through-holes (or pores). For the purposes of the present invention, the term “substantially uniformly sized pores” is intended to mean that the diameter of the pores in a given membrane may vary by up to 5 times.

According to one embodiment, the presently described method may be employed to produce membranes with pores having a diameter of as small as 250 nm and as large as 2500 nm. Moreover, membranes may be produced having pores smaller than 250 nm and even smaller than 20 nm. Furthermore, unlike pores that are formed by drilling, etching or other similar techniques, the pores that are produced via the presently-described method are smooth edged resulting in a membrane with a smooth surface.

According to one embodiment, the degree of compaction influences both membrane thickness and pore density. Accordingly, it is possible to alter the membrane thickness and pore density by altering the degree of compaction of the suspended material.

At 18, a substrate contacts the suspended membrane such that the membrane is transferred to the substrate. The substrate can take any suitable form including, but not limited to, a microfluidic device which may or may not include one or more fluid chambers or channels, fabric, a lithography substrate, or any other flexible or inflexible surface or material suitable for coating with a semi-porous membrane.

Moreover, the membrane may first be transferred to a web, matrix, carrier, or the like, which may or may not include a binding agent. The web, matrix, carrier, etc. (with or without the binding agent) may then be applied to any desirable surface. Examples of suitable binding agents include, but are not limited to, natural glues, artificial glues and thermo-curable or UV curable epoxy adherent resins, etc. Once coated with the semi-porous membrane, the binding agent may be applied to the desirable surface using any suitable technique including, for example, by laminating.

The dipping method may include, for example, drawing the substrate through the membrane at a given velocity while maintaining a given degree of compaction. As stated above, the prescribed drawing speed and direction can influence the thickness of the membrane. According to some embodiments, drawing speeds ranging from 5 mm/min to 100 mm/min can produce membrane thicknesses of between 150 μm and 200 nm.

According to some embodiments, application of the membrane to the substrate may occur as part of a roll-to-roll process such that sheets of substrate material (such as fabric, films or the like) are coated with the semi-porous membrane. The size of the reservoir, the amount of suspension fluid, the amount of material suspended on the suspension fluid, and the size of the substrate drawn through the suspended layer can be adjusted to produce coated sheets of nearly any desired size.

FIG. 2 shows a substrate being coated with a membrane using a roll-to-roll processing technique. As shown, a roll-to-roll device 20 including a plurality of rollers, coils, or other similar, suitable devices, feeds a substrate 22 through a bath 24. Bath 24 contains a suspension fluid 26, over which has been applied a suspended material 28. The suspended material 28 is being compacted by a movable barrier 30. As shown, the uncoated substrate (on right side of figure) is fed through the bath via the roll-to-roll device such that the membrane is able to coat the substrate as the substrate is removed from the bath. The coated substrate may then be collected on roller 32 for further use.

It may be desirable to introduce a time delay between the time when the polymer solution is added to the suspension material and when the substrate is contacted with the suspended film. The amount of time delay, if any, determines the amount of solvent evaporation and needed thickness of the polymeric thin film formation that can occur before the membrane is transferred onto the substrate. According to some embodiments a time delay of between 0 seconds and 300 seconds may be introduced.

The initial position of the substrate typically dictates the way in which the substrate is coated. For example, a single layer of a sufficiently sticky membrane may be transferred to a substrate simply by contacting the substrate to the membrane. Alternatively, the substrate may be submerged in the reservoir before the polymer material is introduced. In such a case, a single pass of the substrate through the liquid-polymer interface (as the substrate is being drawn out of the reservoir) will result in a single layer of the membrane coating the substrate.

Alternatively, the substrate may be initially positioned above (or otherwise outside of) the reservoir. The substrate would then be passed through the liquid-polymer interface twice, once as the substrate enters the reservoir and once as the substrate is removed from the reservoir. This would produce two stacked layers of membrane material on the surface of the substrate. As a further alternative, the substrate could make multiple passes through the liquid-polymer interface, producing multiple layers of membrane coatings. The substrate could be initially positioned in or out of the reservoir, depending on whether an odd or even number of membrane material coatings is desired.

For a roll-to-roll process, the substrate may be fed into the reservoir through a gasket below the suspension fluid surface or through the top of the suspension fluid surface. Moreover, if the substrate enters the tank through the top of the suspension fluid surface, the substrate could enter through the top surface that is separated from the suspended material by the barrier so that there is no film present where the substrate enters the surface. (See, e.g. FIG. 2)

Of course it will be appreciated that the membrane described herein may be formed using a variety of suitable techniques. For example, the membrane of the present invention may be formed by spraying or jetting (such as by inkjet technologies) a PMMA (or other suitable) solution onto a substrate. The thickness and/or concentration of the PMMA solution could be adjusted to alter the thickness, pore size, and density of the membrane, as desired. As non-limiting examples, a 2% PMMA solution could be sprayed onto fabric or over filled chambers to form a coating or chamber cover, respectively. These spraying techniques could be used to apply the membrane onto a single substrate, or could be incorporated into a roll-to-roll (or reel-to-reel) processing technique in order to apply the membrane to multiple substrates or long rolls of substrate.

### Potential Uses

It will be appreciated that the membranes described in the present disclosure can be used in a myriad number of devices, systems, and applications. Descriptions of several, non-limiting, exemplary applications are below. However, it will be appreciated that the membranes of the present disclosure are not limited to only these applications and that various combinations, alterations, and modifications are possible.

### Fluid Containment and Directed Transport

The membranes of the present disclosure could be used as fluid barriers, valves, or filters in various fluidics systems. Examples of suitable fluidics systems include, but are not limited to, MEMS, microinjection mechanisms, and the like.

a. Fluid Barrier

The presently-described membrane can be used as a fluid barrier by allowing the membrane to cover the opening of a fluid chamber. The hydrophobic (or hydrophilic) nature of the membrane in addition to the small pore size would then act to prevent leakage out of the chamber of materials with hydrophilic (or hydrophobic) properties.

To provide additional reliability measures, part or all of the inner or outer surfaces of the fluid chamber could contain a hydrophilic (or hydrophobic) coating, increasing the likelihood that fluid within the chamber would remain in the chamber for as long as desired.

For example, a hydrophobic semi-permeable membrane as presently described may be used as a barrier to keep a material with hydrophilic properties inside of a microchamber in a microinjection device until such time as injection is desired. Likewise, a hydrophilic semi-permeable membrane as presently described may be used as a barrier to keep a material with hydrophobic properties inside of a microchamber in a micro-injection device until such time as injection is desired. Microinjection devices such as that described in co-pending U.S. patent application Ser. No. 11/001,367 typically include an array of addressable drug chambers. Each drug chamber typically includes an ejection mechanism and a microneedle or orifice in fluid communication with the chamber. Upon activation of an ejection mechanism, fluid in the associated chamber is ejected out of the chamber, through the microneedle or orifice, and into the injection recipient. It will be easily understood that in such an application, it is extremely desirable to avoid unintentional or inadvertent leakage or ejection of the fluid out of the chamber, as this could lead to lower or higher dosing than desired, either of which could be harmful to a patient. Accordingly, in order to provide extra protection against inadvertent leakage or ejection, the some portion of the walls of the microchamber could be provided with a hydrophilic coating while the injection orifice or needle could be additionally or alternatively provided with a hydrophobic coating. The discontinuity between the hydrophilic chamber walls and the hydrophobic orifice or needle would then require that additional energy be imparted to the fluid in the drug chamber before ejection could be effected.

b. Valve 10

Alternatively, the membrane of the present disclosure may be situated between two adjacent fluid chambers and may act as a valve for fluid traveling between the two chambers. The valve can be actuated, as desired, by changing the pressure dynamics to encourage movement from one side of the membrane to another. The membrane could act as a fluidic diode, or one-way valve, simply by creating a system where the pressure dynamics can only be altered on one side of the membrane.

Because the membrane has no moving parts, the valve would be unlikely to break and could not get “stuck” (i.e. in an open or closed position). Moreover, because the membrane can be specifically manufactured to have a very small pore size, the valve-size can be scaled down for use with extremely small volumes.

Alternatively, or additionally, the membrane may act as both a chamber cover and a valve. Specifically, the membrane may be placed across the opening of an empty chamber and then fluid forced through the membrane and into the chamber by either a capillary force to extract the fluid after a pre-vacuum treatment or by applying pressure slightly in excess of the hydrophobic repulsion of the membrane. This sterile-filling process may prevent possible contamination during or subsequent to the filling process. Once the pressure is removed, the fluid is constrained to the chamber and will not leak out of the membrane unless force is applied in the opposite direction. Furthermore, other contaminants would be discouraged from passing through the membrane.

c. Filter

As a further alternative, because, as previously stated, the pore size can be controlled by altering the drawing speed and degree of compaction, the membrane of the present invention can also be used as a filter. Accordingly, the size of a membrane's pores can be engineered to prevent passage of undesirable items through the membrane. For example, 250 nm pores could easily filter bacteria, which typically range from about 500 nm to 5000 nm in diameter. Moreover, pores smaller than 20 nm could be engineered by controlling the compaction of the material and drawing speed of the substrate. Pores smaller than 20 nm may be able to filter out viruses (which typically range from about 20-400 nm). Accordingly, such filters could be used to create and/or maintain a sterile environment, to sort biological compounds, or for other applications.

### Fabric Treatment

As stated above, the membrane of the present invention can be manufactured in large sheets which can then be either directly applied to a substrate such as fabric (i.e. by drawing the fabric through the liquid-polymer interface of the bath), or, which can be first transferred to a carrier, which can then applied to fabric. Fabric coated with a hydrophobic membrane of the present invention would have the desirable characteristic of preventing water (or other liquids) from traveling through the membrane to the fabric—essentially making the fabric both stainproof and waterproof. Moreover, because the membrane is porous, the fabric would also be “breathable”—allowing air to travel from one side to the other and allowing sweat vapor to escape.

### Lithography

Because of the controllable, substantially uniform, pore size, the membranes of the present invention can be applied to a substrate and used in a lithographic process as a mask in order to expose micron-, sub-micron-, or nanometer-sized sections of the substrate to various lithographic techniques such as patterning, etching, deposition, growth, etc.

### EXAMPLE I

### Semi-Permeable Membrane Production Using Langmuir-Blodgett (LB) Techniques

An LB trough was filled with water. A mixture of Poly(methyl methacrylate) (PMMA) (2% V/V) in 10 mL ethyl acetate was applied over the water and allowed to partially crosslink. The substrate was formed from a coated silicon wafer. The substrate, which was initially immersed in the water, was drawn through the polymer membrane with a drawing speed of 50 mm/min. and a barrier position creating a 100 mm² area. The membranes were then imaged using a Scanning Electron Microscope (SEM) to determine pore size and density and membrane thickness. Membrane thickness ranged from 200 to 700 nm and pore size was consistently around 1000 nm (1 μm). Images from a scanning electron microscope of exemplary resultant membranes are shown in FIGS. 3 and 4.

### EXAMPLE II

### Use of Semi-Permeable Membrane as a Fluid Barrier

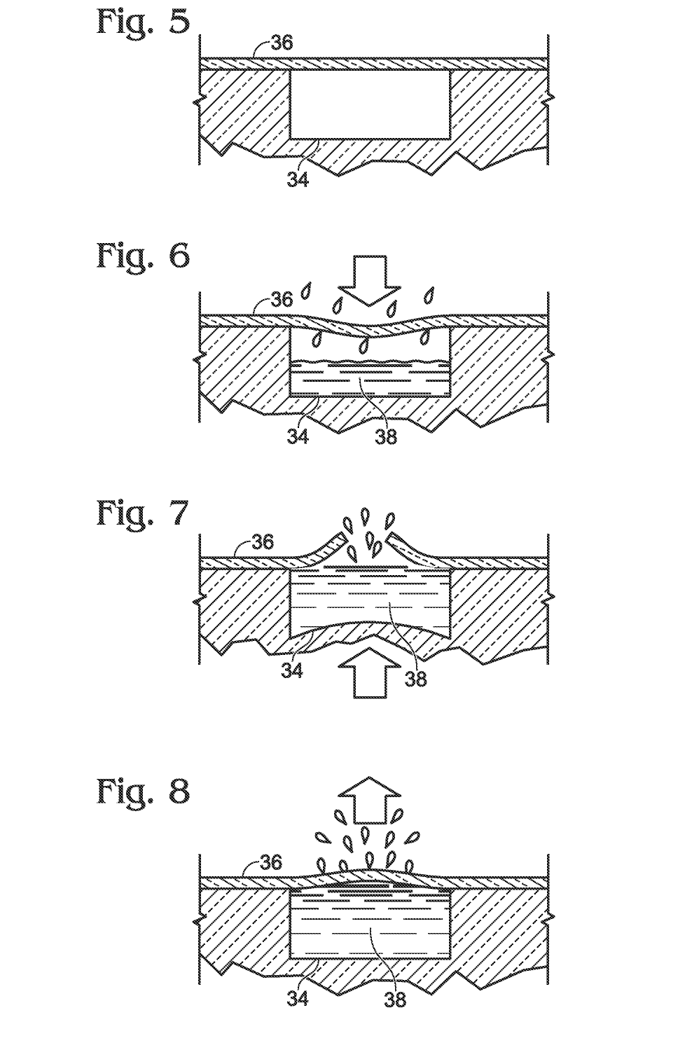

A hydrophobic semi-permeable membrane was formed as described above In Example I. A substrate including a fluid chamber was coated with the membrane such that the membrane covered the opening of the chamber. FIG. 5 is a schematic illustration showing an empty fluid chamber 34 covered with a membrane 36. Pressure slightly in excess of the hydrophobic repulsion was used to force a fluid through the pores and into the chamber from the free side, thereby filling the chamber with the fluid. FIG. 6 is a schematic illustration showing the chamber 34 filling with liquid 38. Significant pressure was then applied from outside the chamber to the chamber wall opposite the membrane to rupture the membrane and cause rapid ejection of the fluid. FIG. 7 is a schematic illustration of the chamber 34 after membrane 36 has burst, releasing the liquid inside the chamber. Alternatively, the amount of force applied to the chamber (e.g. in the form of positive or negative pressure) could have been sufficient to force the liquid to slowly “leak” out of the membrane while keeping the membrane intact (e.g. by using a technique similar to that used to force the fluid into the chamber), as shown schematically in FIG. 8.

### CONCLUSION

While the invention has been described with reference to the exemplary embodiments thereof, those skilled in the art will be able to make various modifications to the described embodiments without departing form the true spirit and scope of the disclosure. Accordingly, the terms and descriptions used herein are set forth by way of illustration only and are not meant as limitations.

What is claimed is:

1. A composition of matter comprising:
a thin film formed from a polymer, the thin film having a thickness of between 200 nm and 150 μm; and
a plurality of smooth-surfaced through-holes extending through the thin film;
wherein the through-holes have a diameter of between 20 nm and 2500 nm.

2. The composition of matter of claim 1 wherein the through-holes have a substantially uniform density.

3. The composition of matter of claim 1 wherein the thin film is chemically dissolvable.

4. The method of claim 1 wherein the thin film is flexible.

5. The composition of matter of claim 1 further comprising a substrate on which the thin film is coated.

6. The composition of matter of 5 wherein the substrate is fabric.

7. The composition of matter of claim 5 wherein the substrate is a lithography substrate, wherein the thin film acts as a mask for lithography techniques.

8. The composition of matter of claim 5 where the substrate includes at least one fluid chamber.

9. The composition of matter of claim 8 wherein the thin film acts as a fluid barrier for the at least one fluid chamber.

10. A method for forming a porous membrane comprising:
providing a reservoir holding a liquid;
suspending a thin film of a polymer material dissolved in a solvent on the liquid;
compacting the polymer material on the liquid so as to form a porous, membrane having substantially uniformly sized through-holes; and
contacting the substrate with the liquid-polymer interface so as to transfer the membrane to the substrate.

11. The method of claim 10 wherein contacting the substrate with the liquid-polymer interface comprises drawing the substrate through the interface at a given drawing speed while maintaining a given degree of compaction.

12. The method of claim 11 further comprising altering the drawing speed to alter the diameter of the through-holes or the thickness of the membrane.

13. The method of claim 11 further comprising altering the degree of compaction to alter the density of the through-holes or the thickness of the membrane.

14. The method of claim 10 further comprising transferring an additional membrane to the substrate, thereby forming a multi-layered membrane.

15. The method of claim 10 wherein the membrane is a thin film having a sub-micron to micron thickness.

16. The method of claim 15 wherein the thin film has a thickness of between 200 and 150 μm.

17. The method of claim 16 wherein the thin film includes a plurality of smooth-surface through-holes.

18. The method of claim 16 wherein the through-holes are between 250 nm and 2500 nm in diameter.

19. The method of claim 10 wherein the polymer is selected from the group consisting of: poly(methyl methacrylate) and its copolymer or block polymer, poly(alkyl acrylate) and its copolymer or block polymer, poly(alkyl methacrylate) and its copolymer or block polymer, poly(acrylamide) and its copolymer or block polymer, poly(N-alkyl acrylamide) and its copolymer or block polymer, poly(N-isopropyl acrylamide) and its copolymer or block polymer, poly(N,N-dialkyl acrylamide) and its copolymer or block polymer, poly(methacrylamide) and its copolymer or block polymer, poly(N-alkyl methacrylamide) and its copolymer or block polymer, poly(N-isopropyl methacrylamide) and its copolymer or block polymer, poly(N,N-dialkyl methacrylamide) and its copolymer or block polymer, poly(ethylene oxide) and its copolymer or block polymer, poly(vinyl chloride) and its copolymer or block polymer, poly(vinyl fluoride) and its copolymer or block polymer, poly(aryl ether) and its copolymer or block polymer, poly(vinyl ether) and its copolymer or block polymer, poly(vinyl acetate) and its copolymer or block polymer, poly(vinyl butyral) and its copolymer or block polymer, poly(vinyl formal) and its copolymer or block polymer, poly(acrylonitrile) and its copolymer or block polymer, poly(methacrylonitrile) and its copolymer or block polymer, poly(siloxane) and its copolymer or block polymer, and poly(styrene) and its copolymer or block polymer, poly(butylene) and its copolymer or block polymer, poly(isobutylene) and its copolymer or block polymer, poly(isoprene) and its copolymer or block polymer, poly(propylene) and its copolymer or block polymer, poly(methylpentene) and its copolymer or block polymer, poly(vinyl alcohol) and its copolymer or block polymer, poly(ethylene glycol) and its copolymer or block polymer.

20. The method of claim 10 where the polymer material is hydrophobic.
